(19) United States
(12) Patent Application Publication
(10) Pub. No.: US 2016/0364801 A1
(43) Pub. Date: Dec. 15, 2016

(54) SYSTEM FOR ASSESSING RETIREMENT SCORE IMPACT BASED ON LINKED USERS

(71) Applicant: Bank of America Corporation, Charlotte, NC (US)

(72) Inventors: Katherine Dintenfass, Charlotte, NC (US); Carrie Anne Hanson, Charlotte, NC (US); Daralyn Marie Nicholson, Charlotte, NC (US); Cameron Darnell Wadley, Waxhaw, NC (US)

(21) Appl. No.: 14/739,923

(22) Filed: Jun. 15, 2015

(51) Int. Cl. G06Q 40/06

(52) U.S. Cl. CPC G06Q 40/06

(57) ABSTRACT

Embodiments of the present invention relate to apparatuses, systems, methods and computer program products for determining impact retirement scores and identifying solutions to aid a user in retirement planning. In one embodiment, a system comprises at least one processing device configured to receive retirement information of a primary user, calculate a retirement score based on a primary user profile, determine relationships of the primary user and hence determine a plurality of secondary users. Further, the at least one processing device is configured to generate user profiles for the secondary users and analyze the user profiles to determine if the secondary users affect the primary user's retirement score. The system then determines the impact retirement score for the primary user, wherein the impact retirement score is an estimate of the primary user's preparedness for the impact of the secondary users on the primary user's retirement.

### FIELD

In general, embodiments of the invention relate to retirement planning, in particular, embodiments of the invention relate to a framework for assessing impact of a user's relationships with secondary users on the retirement planning of the user and providing an impact retirement score for the user.

### BACKGROUND

Retirement planning, in a financial context, refers to the allocation of savings or revenue for retirement in an attempt to achieve financial independence, so that the need to be gainfully employed is optional rather than a necessity. Most retirement planning models provide a target sum that the user should save before retirement, but fail to consider the impact the user's financial relationships on the retirement planning. Further, other costs may be incurred that change retirement planning over time. Therefore determination the preparedness of the user to retire must be ascertained over a period of time by considering the above factors and other aspects that may potentially affect the retirement.

### BRIEF SUMMARY

Embodiments of the present invention address the above needs and/or achieve other advantages by providing apparatuses (e.g., a system, computer program product, and/or other device) and methods for a system to assess retirement planning based on an impact retirement score. The present invention enables a user to plan for specific financial events, planned or otherwise, and incorporate the corresponding expenses into retirement planning by determining one or more secondary users who have relationships with the user. Specifically, the invention enables the user to determine the impact of the one or more secondary users on the user's retirement score by creating and linking user profiles. The invention aids the user by determining impact retirement score for both current and potential future impact. In this regard, the user may be able to select one or more life events of the secondary users and customize the event to determine the effect of the one or more events on user's financial situation. In doing so, the user may keep track of the retirement scenario specifics in real-time for existing and future relationships and as and when the one or more events unfold.

### BRIEF DESCRIPTION OF THE DRAWINGS

Having thus described embodiments of the invention in general terms, reference will be made to the accompanying drawings, where:

FIG. 1 presents an exemplary block diagram of the system environment 100 for implementing the process flows described herein in accordance with embodiments of the present invention;

FIG. 2 illustrates a high level process flow 200 for determining a user profile for a user and a retirement score in accordance with embodiments of the present invention;

FIG. 3 illustrates a high level process flow 300 for determining a first impact retirement score based on determining one or more secondary users and linking user profiles in accordance with embodiments of the present invention;

FIG. 4 illustrates a high level process flow 400 for determining a second impact retirement score based on determining one or more life events in the secondary user's future in accordance with some embodiments of the invention; and

FIG. 5 illustrates a high level process flow 500 for optimization of the impact retirement score by identifying possible solutions in accordance with some embodiments of the invention;

### DETAILED DESCRIPTION OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In some embodiments, a “user” may be a financial institution customer (e.g., an account holder or a person who have an account (e.g., banking account, credit account, or the like)). In one aspect, a user may be any financial institution customer involved in retirement planning with the financial institution or any other affiliate entities associated with the financial institution. In some embodiments, the user may be an individual who may be interested in opening an account with the financial institution. In some other embodiments, a user may be any individual who may be interested in enrolling in the retirement plan offered by the financial institution. In some embodiments, a “user” may be a financial institution employee (e.g., an underwriter, a project manager, an IT specialist, a manager, an administrator, an internal operations analyst, bank teller or the like) capable of operating the system described herein. In some embodiments, a “user” may be any individual or entity who has a “relationship” with a financial institution customer. For purposes of this invention, the term “user” and “customer” may be used interchangeably.

In some embodiments, a “relationship” may be a family relationship. A user in a family relationship with a financial institution customer can comprise a parent, a spouse, a child, a grandparent, a grandchild or the like. In some embodiments, a “relationship” as used herein may be a business relationship. A user in a business relationship with a financial institution customer can comprise a business partner, an investor or the like. In some embodiments, a “relationship” may be an agreement between users. In some embodiments, “relationship” may include marital relations, living relations or the like. In some embodiments a “relationship” may exist between an individual and an “entity”. In some embodiments, a “relationship” may be a direct link between users. In some embodiments, a “relationship” may be an indirect association or connection between users.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g. a banking account), a savings account, an investment account, a money market account, a time deposit, a demand deposit, a pre-paid account, a credit account, a non-monetary user profile that includes only personal information associated with the user, or the like. The account is associated with and/or maintained by an entity. In other embodiments, an “entity” may not be a financial institution. In some embodiments an entity may be any institution, group, association, club, establishment, company, union, authority or the like with which a user may have a relationship.

As used herein, a “user interface” may be a graphical user interface. Typically, a graphical user interface (GUI) is a type of interface that allows users to interact with electronic devices such as graphical icons and visual indicators such as secondary notation, as opposed to using only text via the command line. In some embodiments, the graphical user interface may include both graphical elements and text elements.

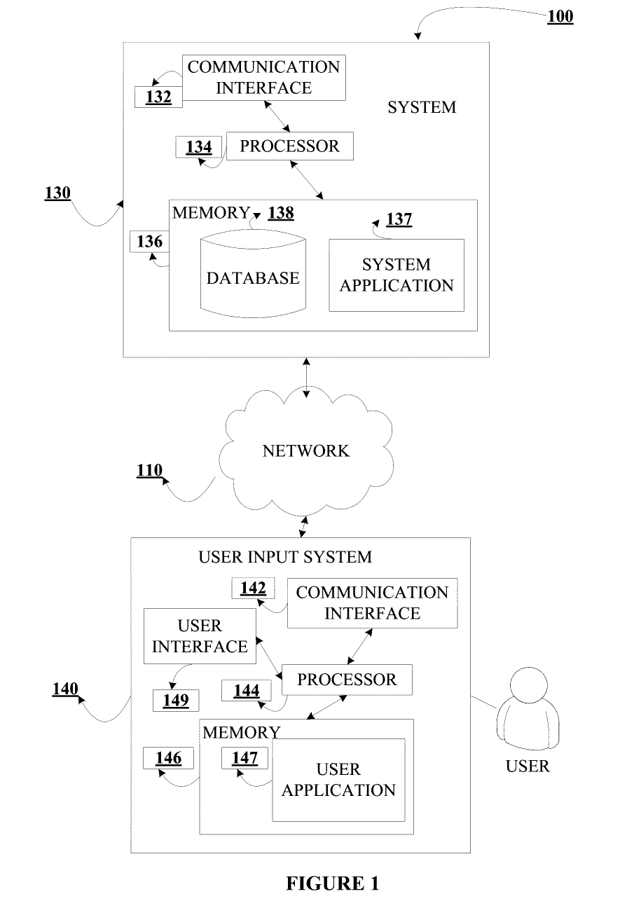

FIG. 1 presents an exemplary block diagram of the system environment 100 for implementing the process flows described herein in accordance with embodiments of the present invention. As illustrated, the system environment 100 includes a network 110, a system 130, and a user input system 140. Also shown in FIG. 1 is a user of the user input system 140. The user input system 140 may be a mobile device or other non-mobile computing device. The user may be a person who uses the user input system 140 to execute a user application 147. The user application 147 may be an application to communicate with the system 130, perform a transaction, input information onto a user interface presented on the user input system 140, or the like. The user application 147 and/or the system application 137 may incorporate one or more parts of any process flow described herein. The user interface is also referred to as a retirement planning interface.

As shown in FIG. 1, the system 130, and the user input system 140 are each operatively and selectively connected to the network 110, which may include one or more separate networks. In addition, the network 110 may include a telecommunication network, local area network (LAN), a wide area network (WAN), and/or a global area network (GAN), such as the Internet. It will also be understood that the network 110 may be secure and/or unsecure and may also include wireless and/or wired and/or optical interconnection technology.

The user input system 140 may include any computerized apparatus that can be configured to perform any one or more of the functions of the user input system 140 described and/or contemplated herein. For example, the user may use the user input system 140 to transmit and/or receive information or commands to and from the system 130. In some embodiments, for example, the user input system 140 may include a personal computer system (e.g. a non-mobile or non-portable computing system, or the like), a mobile computing device, a personal digital assistant, a mobile phone, a tablet computing device, a network device, a smart watch, wearable devices and/or the like. As illustrated in FIG. 1, in accordance with some embodiments of the present invention, the user input system 140 includes a communication interface 142, a processor 144, a memory 146 having an user application 147 stored therein, and a user interface 149. In such embodiments, the communication interface 142 is operatively and selectively connected to the processor 144, which is operatively and selectively connected to the user interface 149 and the memory 146. In some embodiments, the user may use the user application 147 to execute processes described with respect to the process flows described herein. Specifically, the user application 147 executes the process flows described herein.

Each communication interface described herein, including the communication interface 142, generally includes hardware, and, in some instances, software, that enables the user input system 140, to transport, send, receive, and/or otherwise communicate information to and/or from the communication interface of one or more other systems on the network 110. For example, the communication interface 142 of the user input system 140 may include a wireless transceiver, modem, server, electrical connection, and/or other electronic device that operatively connects the user input system 140 to another system such as the system 130. The wireless transceiver may include a radio circuit to enable wireless transmission and reception of information. Additionally, the user input system 140 may include a positioning system. The positioning system (e.g. a global positioning system (GPS), a network address (IP address) positioning system, a positioning system based on the nearest cell tower location, or the like) may enable at least the user input system 140 or an external server or computing device in communication with the user input system 140 to determine the location (e.g. location coordinates) of the user input system 140. Additionally, the user input system may comprise a data capture device, AR technology or the like.

Each processor described herein, including the processor 144, generally includes circuitry for implementing the audio, visual, and/or logic functions of the user input system 140. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 147 of the memory 146 of the user input system 140.

Each memory device described herein, including the memory 146 for storing the user application 147 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system. In some embodiments the memory 146 is divided into multiple sectors. In such embodiments some sectors of the memory 146 may be isolated from other sectors, in that the files stored in one isolated sector are not permitted to act on files outside that sector. In such embodiments the isolated sector of memory 146 may be quarantine sectors. In some embodiments memory 146 comprises shared memory and/or distributed memory. In some embodiments the memory 146 comprises virtual memory.

As shown in FIG. 1, the memory 146 includes the user application 147. In some embodiments, the user application 147 includes an interface for communicating with, navigating, controlling, configuring, and/or using the user input system 140. In some embodiments, the user application 147 includes computer-executable program code portions for instructing the processor 144 to perform one or more of the functions of the user application 147 described and/or contemplated herein. In some embodiments, the user application 147 may include and/or use one or more network and/or system communication protocols.

Also shown in FIG. 1 is the user interface 149. In some embodiments, the user interface 149 includes one or more output devices, such as a display and/or speaker, for presenting information to the user. In some embodiments, the user interface 149 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user. In some embodiments, the user interface 149 includes the input and display devices of a mobile device, which are operable to receive and display information.

FIG. 1 also illustrates a system 130, in accordance with an embodiment of the present invention. The system 130 may refer to the “apparatus” described herein. The system 130 may include any computerized apparatus that can be configured to perform any one or more of the functions of the system 130 described and/or contemplated herein. In accordance with some embodiments, for example, the system 130 may include a computer network, an engine, a platform, a server, a database system, a front end system, a back end system, a personal computer system, and/or the like. Therefore, the system 130 may be a server managed by the business. The system 130 may be located at the facility associated with the business or remotely from the facility associated with the business or in cloud storage. In some embodiments, such as the one illustrated in FIG. 1, the system 130 includes a communication interface 132, a processor 134, and a memory 136, which includes a system application 137 and a structured database 138 stored therein. As shown, the communication interface 132 is operatively and selectively connected to the processor 134, which is operatively and selectively connected to the memory 136. In some embodiments the memory 136 is divided into multiple sectors. In such embodiments some sectors of the memory 136 may be isolated from other sectors, in that the files stored in one isolated sector are not permitted to act on files outside that sector. In such embodiments the isolated sector of memory 136 may be quarantine sectors. In some embodiments memory 136 comprises shared memory and/or distributed memory. In some embodiments the memory 136 comprises virtual memory.

It will be understood that the system application 137 may be configured to implement any one or more portions of the various user interfaces and/or process flow described herein. The system application 137 may interact with the user application 147. It will also be understood that, in some embodiments, the memory includes other applications. It will also be understood that, in some embodiments, the system application 137 is configured to communicate with the structured database 138, the user input system 140, or the like.

It will be further understood that, in some embodiments, the system application 137 includes computer-executable program code portions for instructing the processor 134 to perform any one or more of the functions of the system application 137 described and/or contemplated herein. In some embodiments, the system application 137 may include and/or use one or more network and/or system communication protocols. In some embodiments the processor 134 comprises multiple processing units or multiple processors. In such embodiments the processor 134 may conduct parallel computing, in that the processor 134 may execute tasks simultaneously on multiple processing units to reduce the run time and reduce the load on the processor. In some embodiments the processing units of the processor 134 may be operatively coupled to a shared memory of memory 136. In some embodiments each of the processing units may be operatively coupled to distributed memory or individual memory sectors of memory 136 so that malicious code and threats can be isolated and security of the financial data can be sustained. In some embodiments the user input system can only access one memory sector of the memory 136 through one or more processing units of the processor 134.

In addition to the system application 137, the memory 136 also includes the structured database 138. As used herein, the structured database 138 may be one or more distinct and/or remote databases. In some embodiments, the structured database 138 is not located within the system and is instead located remotely from the system. In some embodiments, the structured database 138 stores information or data described herein.

It will be understood that the structured database 138 may include any one or more storage devices, including, but not limited to, datastores, databases, and/or any of the other storage devices typically associated with a computer system. It will also be understood that the structured database 138 may store information in any known way, such as, for example, by using one or more computer codes and/or languages, alphanumeric character strings, data sets, figures, tables, charts, links, documents, and/or the like. Further, in some embodiments, the structured database 138 may include information associated with one or more applications, such as, for example, the system application 137. It will also be understood that, in some embodiments, the structured database 138 provides a substantially real-time representation of the information stored therein, so that, for example, when the processor 134 accesses the structured database 138, the information stored therein is current or substantially current.

It will be understood that the embodiment of the system environment illustrated in FIG. 1 is exemplary and that other embodiments may vary. As another example, in some embodiments, the system 130 includes more, less, or different components. As another example, in some embodiments, some or all of the portions of the system environment 100 may be combined into a single portion. Likewise, in some embodiments, some or all of the portions of the system 130 may be separated into two or more distinct portions.

In addition, the various portions of the system environment 100 may be maintained for and/or by the same or separate parties. It will also be understood that the system 130 may include and/or implement any embodiment of the present invention described and/or contemplated herein. For example, in some embodiments, the system 130 is configured to implement any one or more of the embodiments of the process flows described and/or contemplated herein in connection any process flow described herein. Additionally, the system 130 or the user input system 140 is configured to initiate presentation of any of the user interfaces described herein. In some embodiments the system 130 is configured to establish communication with the user input system 140 to transmit messages, alerts or the like.

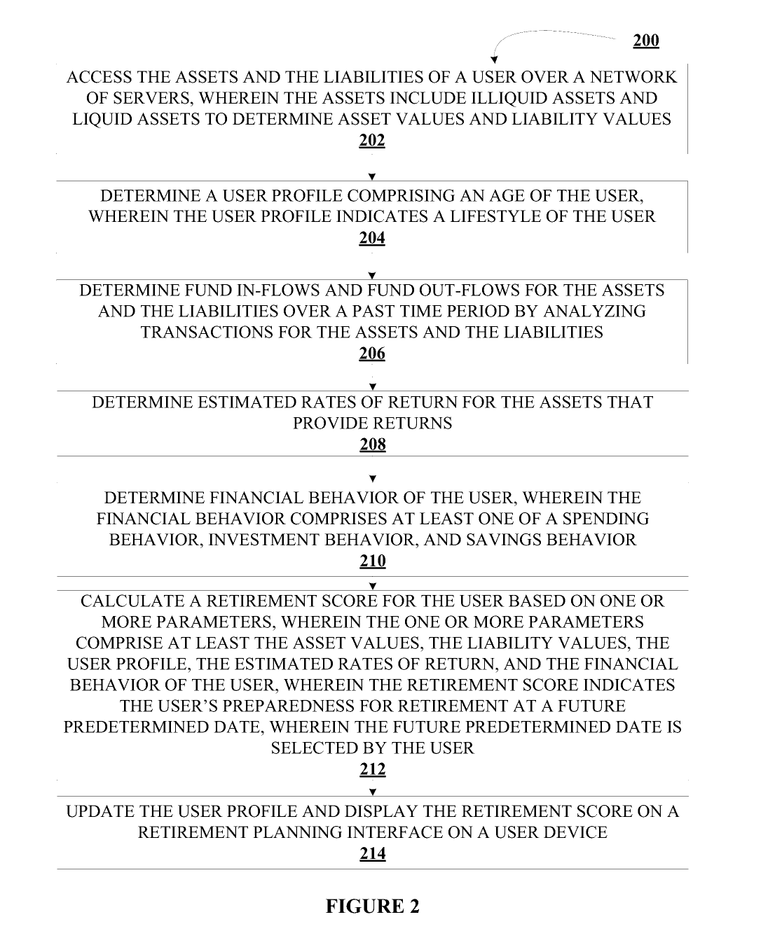

FIG. 2 illustrates a high level process flow for determining a user profile and a retirement score 200. As illustrated by block 202, embodiments of the invention comprise receiving accessing the assets and liabilities of a user over a network of distributed servers, wherein the assets include illiquid assets and liquid assets. In some embodiments the information is received via the retirement planning interface. The user's assets may include but are not limited to checking accounts, savings accounts, investment accounts (e.g., with regular disbursements and penalties for principal withdrawals, or self-directed accounts that are more liquid without penalties), annuity accounts (e.g., social security, claim awards, reverse mortgages, or the like), insurances benefit accounts (e.g., one time or reoccurring), property owned by the user (e.g., investment property, rental property, or the like), or other like assets that may provide regular or semi-regular recurring payments, assets that are or are similar to cash accounts, or assets that need to be sold in order to realize cash values of the assets. In some embodiments the assets may be illiquid (e.g., have penalties or may take time to convert into cash) or may be liquid (e.g., can be converted to cash in a couple of days without penalty). In one aspect, the process flow includes determining a user's asset values (e.g., balances of the account, current or estimated future fair market values of the property, or the like) and liability values (e.g., amount owed, or the like). The user's liabilities may include a mortgage, long and short term debit, payments owed on other personal property or legal judgments against the user, or the like). In some embodiments all of the assets and liabilities are determined in order to get an idea of what the values of the assets and liabilities are in order to determine how long the inflows and outflows for the user may last.

As shown in block 204, embodiments of the invention further include determining a user profile comprising an age of the user. In some embodiments the user profile is a comprehensive profile can comprise multiple sections indicating a lifestyle of the user, current financial behavior of the user, relationships of the user, financial history of the user, future projections including the goals of the user. For the user profile indicating the lifestyle of the user, the system may be configured to determine the user profile based on at least one or more past transactions of the user, a geographic location of the user, an income level, an amount of outgoing funds, asset values, liability values, asset types, spending habits, saving habits or the like. In one aspect, the user profile includes at least information identifying the user. In some embodiments, the system may be configured to establish predefined user profiles including, but not limited to travel profiles, homebody, luxury spender, thrifty saver, risk taker, or the like. For example, for the thrifty saver lifestyle the user may indicate that he/she may downsize the user's home in retirement, sell a vacation home, reduce travel expenses, or the like. The profiles may be pre-programed by the financial institution and/or programmable by the user to illustrate how the user plans on living in retirement. Other lifestyles illustrate if the user will spend less, the same, or more during retirement. In some embodiments the user profile is automatically prefilled by the system with information obtained from various databases and the user may be asked to verify the obtained information. In some embodiments the user is asked to provide information to complete the user profile.

In some embodiments, the system may be configured to enable the user to customize the user profile. In this regard, the system may be configured to enable the user to select at least one of the predetermined user profiles and customize the at least one selected user profile according to the characteristics of the user by providing additional information. In one aspect, the system may be configured to initiate presentation of one or more selectable options on the retirement planning interface on the user device to enable the user to provide the additional information to customize the selected predetermined user profile. In some embodiments the user profile is stored in a searchable and retrievable database.

As shown in block 206, embodiments of the invention further include determining fund in-flows and fund out-flows for the assets and liabilities over a past time period by analyzing transactions for the assets and the liabilities. In one aspect, the fund in-flows include funds received from or deposited into the user's assets (e.g., user's accounts, or the like), such as paychecks, 401K disbursements, pension disbursements, or the like. Block 206 further illustrates that past outflows of funds from the user's assets (e.g., user's accounts, or the like) are determined, such as payments for housing (e.g., rent or mortgage), bills, health care insurance and other costs, heat, water, food, or like, which illustrates all of the essential (e.g., necessary or necessary to the user) costs that cover what the user currently uses to live.

At block 208, embodiments of the invention further include determining estimated rates of return for the assets that provide returns. In some embodiments, the assets may include estimated rates of returns such that not only are the disbursements used in determining the retirement score, but the principal and growth of the principal over time may be used in determining the retirement score.

At block 210, embodiments of the invention further include determining financial behavior of the user, wherein the financial behavior comprises at least one of a spending behavior, investment behavior, and savings behavior. In one aspect, determining financial behavior of the user may include determining a spending pattern, investment pattern, and savings pattern of the user over a predetermined past period of time. In one aspect, determining the financial behavior of the user is based on at least the user profile. In this regard, the system may be configured to generate one or more predetermined questions to enable the user to provide additional information regarding the user's financial behavior to the system. In one aspect, the predetermined questions may enable the system to receive information associated with the personality, values, opinions, attitudes, interests, lifestyles, goals or the like of the user.

At block 212, embodiments of the invention further include calculating a retirement score for the user based on one or more parameters, wherein the one or more parameters comprise at least the asset values, the liability values, the user profile, the estimated rates of return, and the financial behavior of the user, wherein the retirement score indicates the user's preparedness for retirement at a future predetermined date, wherein the future predetermined date is selected by the user. In some embodiments, a high retirement score reflects better preparedness for retirement. At block 214, embodiments of the invention further include updating the user profile with the calculated retirement score and displaying the retirement score on the retirement planning interface on a user device.

In some embodiments, the system calculates the retirement score based at least in part on an amount of savings of the user for retirement, an amount of savings the user needs during retirement, and a number of years the user has to get ready for retirement. With respect to the amount of savings of the user for retirement, the system may identify savings and other retirement accounts from the user profile. The system may automatically determine a retirement account based on the type of account (e.g. 401K). In other embodiments, the user may designate an account as a retirement account. Where the account is an interest bearing account, the system may calculate at least a future amount based on the system collecting and compounding interest. For example, the user may have designated a savings account as a retirement account that generates 1% per annum. The system further determines that the user contributes $100 per month into the savings account. The system may determine an available amount of funds at a future period of time based on such information. The future period of time may coincide with the retirement of the user. Where the account is an investment account, the system may determine based on market information, an amount each investment vehicle in account will be worth at a future period of time. In addition to account information, the system may determine that the user maintains an interest of ownership in real property. With respect to the user's ownership in real property, the system may determine based on historic market information of the property, a value of the property at a future period of time. The system may further determine whether the property generates an income (e.g. rent, timber sale, farm product). The system may valuate the land based on the generated income of the property. In other embodiments, the system may determine an amount the user will likely earn prior to retirement and an amount the user will save from the earnings for retirement. The system may view employment history of the user to determine a current salary of the user. Such employment history may include the occupation of the user. Additionally, the system may determine an expected increase in the salary of the user over a period of time prior to retirement. For example, the system may determine that the user is a teacher and paid a salary of $X.XX per annum. The user has been teaching for 5 years. The system may determine based on employment data that the salary of the user will increase 7% per year until the user retires. The system may determine an expected amount that the user will likely save for retirement from the increase in salary. In some embodiments, the system may determine that the user will receive benefits after retirement such as military and government benefits. These benefits will be included into a post-retirement income that will offset any amount the user may require to save for retirement.

In other embodiments, the system may determine that the user may want to partially retire and continue to receive an additional post-retirement income. In other embodiments, the system may further determine the user wants to start a business for retirement. The system may determine the amount of money the user needs to start the business and calculate the retirement score based on the needs to start the business. The system may further determine an expected salary from the business.

With respect to the amount of savings the user needs during retirement, the system may determine the cost of living for an area in which the user lives. Cost of living may include necessities such as groceries, rent, and insurance. Cost of living may also include other financial factors such as money for vacations, club memberships and such. In other embodiments, the system may determine based on past financial history of the user, the spending habits of the user to determine the amount the user needs during retirement. When the system determines past spending habits, the system may further determine whether the user plans to live a similar life style to which the user has lived prior to retirement. Such information may be gathered as a result of sending a questionnaire to the user. The information may further be received from a third-party consultant of the user (e.g. financial planner). In one example, the system may determine that the user has a property worth $X.XX amount of dollars which the user uses a primary residence. The system petitions the user whether the user intends to retain the property as a retirement home. If the user answers that the user intends to sell the property and rent a smaller property, the system would calculate the amount from a sale of the property and the amount the user would need for rent. The system may also determine insurance for the user during retirement. When the system determines that the user will receive a post-retirement income, the system may use such income to determine the amount the user needs to save after retirement.

With respect to amount of time the user has to save for retirement, the system may determine the current age of the user and the age at which the user would like to retire or partially retire. In other embodiments, the retirement score may include an age of retirement for a given score. For example, after the system receives the user profile and determines an amount the user would need for retirement, the system may determine different retirement ages for the user. The ages may be determined arbitrarily (e.g. the age of the user ten years in the future up until the user is a certain age), or the ages may be supplied by the user. After the retirement ages have been determined, the system may further calculate a retirement score for each age. For example, the user may supply a retirement age of 40, 45, 50, 55, and 60. Based on the both the amount the user has saved for retirement and the need of the user during retirement, the system may determine the retirement score for each age. Such score determines the readiness of the user to retire when the given age is achieved. In another embodiment, the retirement score is an age at which the user may retire.

As discussed above, the retirement score is calculated based on one or more parameters. Some of these parameters (e.g., fund in-flows and fund out-flows) may include continuously varying values which when used to calculate the retirement score may not result in the most accurate representation of the retirement score. In this regard, the system may be configured to represent the retirement score according to a confidence score. The confidence score is computed for each retirement score. The factors that affect the confidence score include amount of relevant data available for analysis, percentage completion of the user profile, percentage of accurate and verifiable, probability of occurrence of future events and the like. For example, if only a small amount of data is available and the accuracy of the data cannot be verified the confidence score can be low even for a high retirement score. If sufficient data is available, but the calculation of the retirement score depends more heavily on possible future income, the uncertainty results in a lower confidence score. If the available data is accurate and verifiable, the result is a high confidence score. In some embodiments each of the factors can have weights associated with them based on their importance and scores can be assigned individually and then combined according to the weights to determine a confidence score. The confidence score may be represented in any format including, but not limited to, a percentage, a ranking, a numerical value, or the like. In doing so, the user may be able to gauge the accuracy of the retirement score. For example, a retirement score of 40/100 with a confidence score of 50% may indicate that the retirement score may not be the most accurate representation of the retirement score with a confidence level of only 50%. A lower confidence score may indicate that the data (one or more parameters) used in the calculation of the retirement score are either incomplete or dated. This enables the user to review the information initially provided and update the information to retrieve an accurate representation of the retirement score. In some embodiments the determined user profile and the calculated scores are stored in a secure section of the memory which can be accessed only by one processor.

In some embodiments, the system may be configured to receive a desired future predetermined date for retirement from the user through the retirement planning interface. In response, the system may be configured to recalculate a new retirement score for the user based on the desired future predetermined date for retirement. In response to calculating a new retirement score, the system may be configured to display the new retirement score and the desired future predetermined date on the user interface of the user device.

In one aspect, the system may be configured to track the retirement score of the user over a predetermined past time period. In this regard, the system may be configured to enable the user to select the predetermined past time period. And in response, the system may initiate presentation of the retirement score of the user relative to a retirement score associated with one or more users over the predetermined past time period, wherein the one or more users are determined to have a substantially similar user profile as that of the user.

In some embodiments, the retirement score may be used by entities such as lenders (banks and credit card companies) to evaluate potential risk posed by lending funds to the user. In this regard, the retirement score may be used in conjunction with other credit scores (e.g. FICO score) to evaluate such risk.

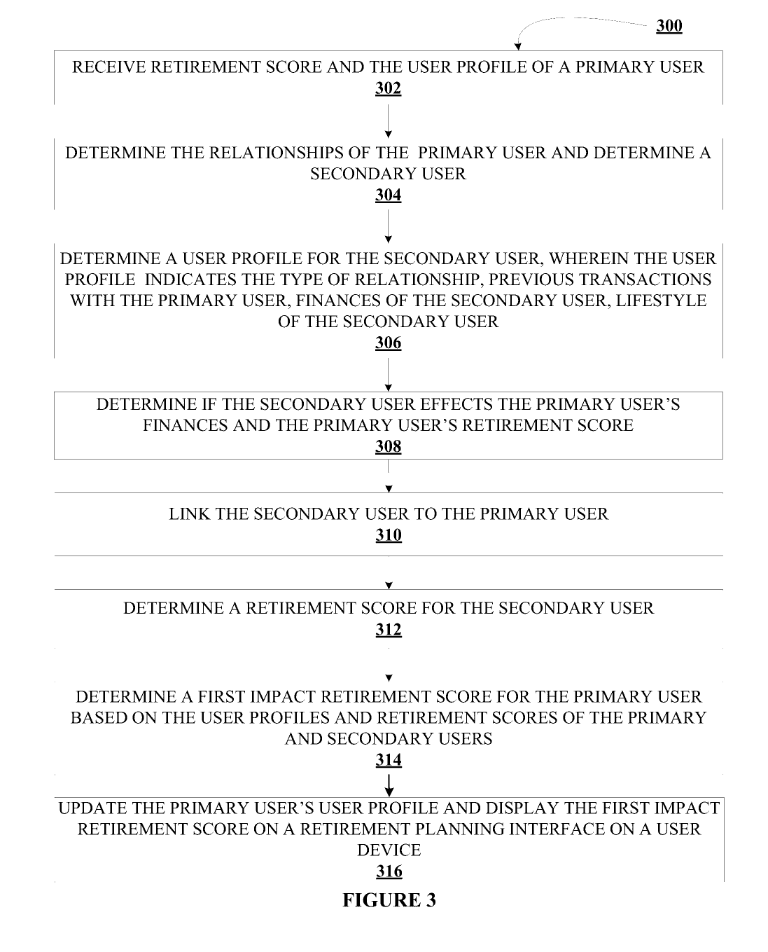

FIG. 3 illustrates a high level process flow for determining a first impact retirement score based on determining one or more secondary users and linking user profiles 300. As shown in block 302, embodiments of the invention further include receiving retirement information of a primary user comprising a user profile, financial data, and previously calculated retirement scores of the primary user. The user profile may be associated with a financial institution, a financial advisor or retirement planner, and an insurance provider. The user profile may include all or some of the information related to assets and liabilities of the primary user, lifestyle of the user and the like as explained and defined in other portions of the specification.

At block 304, the system analyses the user profile of the primary user and determines all possible relationships of the primary user with the secondary users. In some embodiments the relationship is between the primary user and the secondary user. In some embodiments the system automatically identifies relationships based on previous transaction history and potential future transactions. In some embodiments the system receives the relationship information from a user through a user input device. In some embodiments the system determines the possible relationships and seeks confirmation from the primary user through the retirement planning interface of the user device. In some embodiments the system receives information regarding the secondary users form the primary user through the retirement planning interface. In some embodiments the determination of all possible relationships is conducted by one or more processors of the system, and the results are stored in a temporary memory location in one or more sections of the memory.

The system then generates user profiles for each of the secondary users as shown in block 306. This user profile may be substantially similar to the user profile described in other portions of the specification. The user profile can comprise relevant information regarding the type of relationship, duration of the relationship, previous transactions with the primary user, potential future transactions, finances of the secondary user, lifestyle of the secondary user and the like. In some embodiments the user profiles for the secondary users are automatically prefilled by the system only to the extent that, enough information has been acquired to make a preliminary determination that the secondary user affects the finances of the primary user either now or in the future. For example if the secondary user is a neighbor or an acquaintance and the system determines that there are no significant financial transactions between the primary user and the secondary user, the system merely prefills the information regarding the type of relationship and the duration of the relationship. In some embodiments, information for the user profiles of the secondary users is obtained from various databases. In some embodiments the system receives information regarding the secondary users from the primary user. In some embodiments the system my initiate requests for information from the secondary users. The requests may be in writing, a phone call, an email message or any other suitable means of communication. In some embodiments the determined user profiles are stored in a temporary memory location in one or more sections of the memory.

At block 308, the system then analyzes the user profiles of each of the secondary users to determine if the secondary users affect the finances of the primary user now or in the future, causing change to the existing retirement planning and the retirement score of the primary user. For example, the secondary user may be a parent of the primary user. The system could determine that the parent is elderly and that the parent receives financial assistance from the primary user. As another example a secondary user might be an institution that the primary user invests in. The system might determine that the primary user invests a certain amount of money every month, and will do so for a prolonged period of time. In another instance the primary user may be receiving income from the secondary user, either currently or in the future. In some instances the system could determine that one or more secondary users would not have any significant potential impact on the primary user's finances now or in the future and would then discard the one or more secondary users from subsequent analysis. In some embodiments, once the system determines that a secondary user could potentially impact the primary user's finances, the system could them transfer only the data corresponding to the said secondary user to another memory location from the temporary memory location and discard all non-relevant data. In some embodiments the system conducts the blocks 302, 304, 306, 308 and other processes in parallel on one or more processors at multiple memory locations to reduce the load on the system and utilize the available memory efficiently and effectively. For instance, one or more processors might begin analyzing the user profiles at block 308, while other processors continue to determine possible relationships of the primary user as shown in block 308. This facilitates quicker analysis.

On determining that one or more secondary users affect the primary user's finances, the system then automatically initiates linking the secondary user's profiles to that of the primary user, as shown in block 310. In some embodiments the system seeks confirmation form the primary user and/or the secondary user before completing the linking process. In some embodiments, the system may receive requests to link the secondary users' profiles. After receiving the request to link the user profiles, the system may be configured to authenticate the request. Such authentication may be based at least in part on authentication credentials of the primary user. In other embodiments, the authentication credentials may be based in part on authentication credentials of the secondary user. While in yet other embodiments, the authentication credentials are based on authentication credentials of both the primary user and the secondary user. Based on receiving the request to link the user profile of the secondary user to the user profile of the primary user, the system may create a link between the different user profiles. In some embodiments the user profiles are stored in separate sections of memory. Establishing a link may be enabling a single processor to access data from all the linked user profiles. Further, the system determines a retirement score for each of the linked secondary users as shown in block 312. This determination of the retirement score is similar to that described elsewhere in the specification. In some embodiments the secondary user is an entity and the retirement score might reflect the financial security of the primary user's investment.

At block 314, the system determines the first impact retirement score for the primary user. The first impact retirement score reflects the impact of the secondary users on the primary user's retirement by analyzing existing impact and projected future impact based on current or past transactions. The impact can be a positive impact or a negative impact. In some embodiments the first impact retirement score is a combination of the primary and secondary users' retirement scores. The combination may be accomplished by ranking and assigning weights to the secondary users on the basis of their level of impact on the primary user. In some embodiments the first impact retirement score is computed by aggregating financial data from the user profiles under various categories like net projected income, net projected expenses, and probability of occurrence, projected spending behavior and the like and then determining a score for each of the categories. In some embodiments the aggregation is achieved based on assigning weights on the basis of their level of impact on the primary user. This allows the user to gauge which aspects of his/her retirement are most impacted by the secondary users. The system may automatically determine what categories are likely to affect the primary user more or the system may receive an input from the primary user regarding what categories to consider.

In some embodiments the aggregated data is utilized to build a second user profile for the primary user and the first impact retirement score is computed using the second user profile. In this respect the computation of the first impact retirement score may be substantially similar to the computation of the retirement score. For example, the system may be configured to determine that one or more secondary users have a family relationship with the primary user or that one or more secondary users live in the same household as the primary user. In response the system may determine the first impact retirement score for the household.

In some embodiments the first impact retirement score may reflect a neutral impact. For example, if one secondary user has a positive impact and another secondary user has negative impact the first impact retirement score may be neutral. In some embodiments the first impact retirement score is determined for every secondary user to determine the impact of every secondary user on the primary user. In this regard the first impact retirement score could comprise of multiple categories. The first impact retirement score and scores assigned for each of the categories may be quantitative scores or qualitative score. The score may be numerical, alphanumeric or a combination. In some embodiments the score is a rating system wherein grades are assigned based on adherence of the primary user's financial preparedness to certain previously calculated threshold values like optimum percentage savings, expenditure limit and the like. At block 316, embodiments of the invention further include updating the primary user's profile with the calculated first impact retirement score and displaying the retirement score on the retirement planning interface on a user device. In some embodiments this determination of the first impact retirement score is carried out in real time by the system 130. The primary user may access at least a portion the user profile stored in memory 136 based on the user's access permissions, through a network and input the details of a secondary user from the user input system 140. The system 130 then conducts blocks 306 through 314 and displays the first impact retirement score instantaneously on the user device. This embodiment enables the primary user to gauge potential impact of relationships. For instance the primary user may determine the first impact retirement score before making an investment.

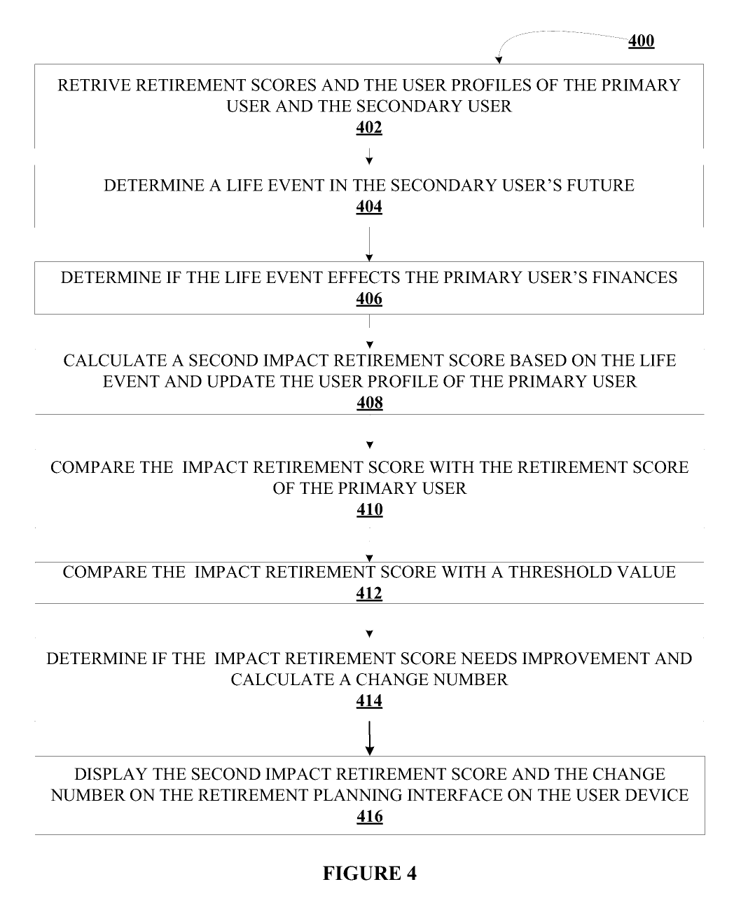

FIG. 4 illustrates a high level process flow 400 for determining a second impact retirement score based on determining one or more life events in the secondary user's future in accordance with some embodiments of the invention. The second impact retirement score is calculated to assess potential future impact on the primary user's retirement. This is determined to ensure that in addition to being prepared for projected and predetermined expenses, the primary user is also prepared for probable but uncertain life events in the future when status quo would not be maintained. As shown in block 402, embodiments of the invention further include receiving previously calculated retirement scores comprising retirement score and impact retirement score of the primary user and retirement scores of the secondary users and user profiles of the primary user and associated secondary users.

At block 404, the system determines possible life events for each of the secondary user that is likely to occur in the secondary user's future. For example the secondary user might be a child of the primary user. The system could then determine a possible life event of the child going to college, or the child getting married or the like at a predetermined date in the future. The predetermined date could be a specific date or a range of likely dates. As another example the secondary user might be a parent or a grandparent of the primary user and the system could determine life events that the secondary user would retire in the coming years or that the secondary user would require healthcare. As another example the system may determine that the primary user's investment with a secondary user that currently provides income could cease in the future. The system could also determine life events in the form of possible inheritances, compensations and the like. The life event could be a probable change in location of the secondary user that would affect the secondary user's finances. The life events could also include medical expenses, divorce settlements, estate taxes and the like. The system may automatically determine one or more life event based on the user profiles or could request information from the primary and/or secondary users. In some embodiments the system is configured to allow the primary and/or secondary users to customize the life events by choosing from existing events on the retirement planning interface and adding or modifying information based on their access permissions.

At block 406, the system determines if each of the determined life events could influence the primary user's finances. The system analyses each of the secondary users' user profiles and determines if they are suitably prepared for the life event and would not require further assistance. For instance the system may determine that a secondary user has medical or life insurance or a college savings account. On determination that one or more secondary user's life events would require assistance from the primary user and affects the primary user's finances, the system then calculates a second impact retirement score for the primary user at block 408. The computation of the second impact retirement score is substantially similar to the determination of the first impact retirement score. In some embodiments the second impact retirement score is computed by modifying the first impact retirement score corresponding to each of the life events that affect the primary user's finances. If the impact is positive the second impact retirement score is greater than the first impact retirement score and if the impact is of expenditure in nature, then second impact retirement score is lower. In some embodiments the second impact retirement score of the primary user comprises multiple parts, each part corresponding to a specific life event of the secondary users. In some embodiments the multiple parts refer to each of the secondary users. In some embodiments the system determines a second impact retirement score for the primary user considering each of the secondary users irrespective of whether the secondary user has an associated life event and whether the event would affect the primary user's finances. In this instance the second impact retirement score would be same as the first impact retirement score if a life event was not determined for the secondary user or if the life event did not affect the primary users finances.

The determination of the second impact retirement score is accompanied by the determination of an associated confidence score. The confidence score in this instance indicates the probability of occurrence of the life event, the amount of relevant data available for analysis and the like. For example, the system determines that the possible life event of the spouse of the primary user is change of job or change of job location. But on determining that the spouse retires in six months, the system assigns a low confidence score since the probability of occurrence of the life event is low. Therefore, the impact of life events on the retirement score can be adequately analyzed based on the level of impact (second impact retirement score) and the probability of impact (confidence score). In some embodiments the primary user can assess impact of each of the life events individually through the retirement planning interface.

At block 410, the first impact retirement score and the second impact retirement score are compared with the retirement score of the primary user. The first impact retirement score and the second impact retirement score are hereinafter referred to collectively as an impact retirement score. In some embodiments the system determines the impact retirement score with parts comprising the first impact retirement score and/or the second impact retirement score. For instance, if there are no life events that affect the retirement score, the impact retirement score would only consist of the first impact retirement score. The impact retirement score is compared to the retirement score of the primary user to access the impact of the relationships of the primary user on the primary user's existing retirement scenario. If the impact retirement score is higher than the retirement score the system determines that the primary user is financially secure with respect to the secondary users. If the first impact retirement score is lower than the retirement score the system determines that the primary user needs to modify existing finances with respect to secondary users to account for the change. If the second impact retirement score is lower than the retirement score the system determines that the primary user would require new financial products to be prepared for life events. On determination that the existing finances of the primary user need to be modified the system may initiate communication of one or more notification and alerts to user devices.

At block 412, the retirement score and the impact retirement score of the primary user are compared to a threshold value. In some embodiments the threshold value is automatically determined by the system to be an optimum retirement score for the primary user. The system may determine the optimum retirement score for each of the retirement score and the impact retirement score such that the optimum retirement score achieves the primary user's goals. In some embodiments the primary user determines the threshold value comprising a target retirement score. In some embodiments the threshold value is an average retirement score of the peers with substantially similar user profiles of the primary user. For example, the user who is 25 years old may not save as much as other older users, but may be saving more than his/her peers with a substantially similar user profile. In this case, the user's retirement score may be low compared to the retirement scores of older individuals but may be high when compared to peers with a substantially similar user profile. After comparison with the threshold value the system determines a change number at block 414. The change number indicates the level of change required to meet optimum or threshold standards. If the change number is high, it indicates that the impact retirement score is lesser that the threshold value and drastic change is required to the existing financial planning of the primary user. If the change number is moderately high, while it indicates that the impact retirement score is lesser that the threshold value, the system also determines that the primary user can benefit by merely supplementing the existing finances with new financial products. If the change number is low, it indicates that the impact retirement score is equal to or greater than the threshold value, and the system determines that the primary user has an optimal retirement score. In some instances the change number also indicates how quickly the changes to the existing finances of the primary user have to be implemented to stay on track of attaining retirement goals. At block 416, the determined second impact retirement score and the change number are displayed on the retirement planning interface on the user device.

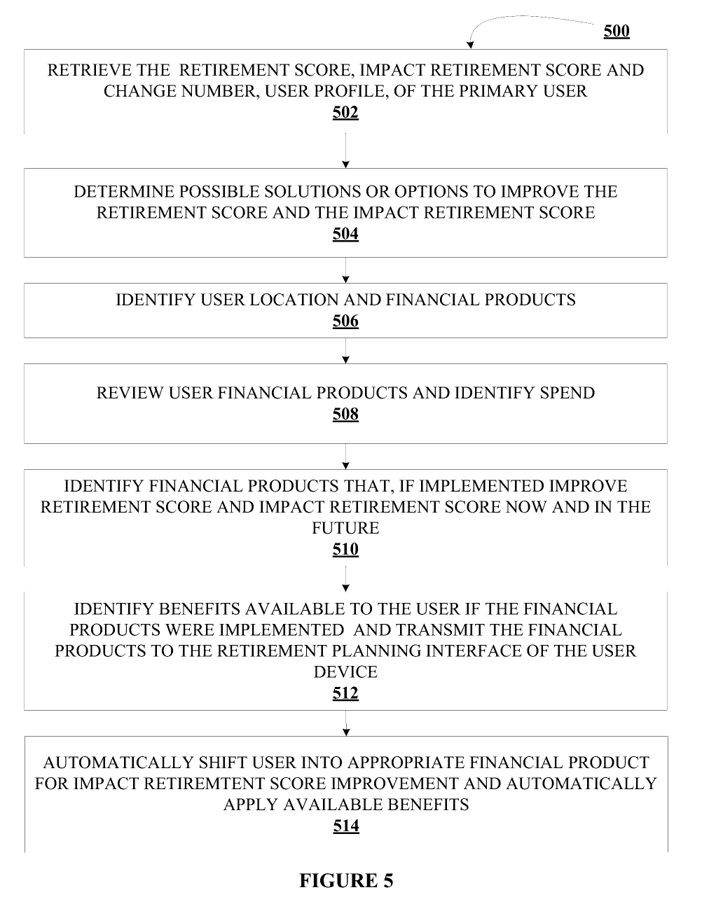

FIG. 5 illustrates a high level process flow 500 for optimization of the impact retirement score by identifying possible solutions or options in accordance with some embodiments of the invention. In this way, the system may provide tips to improve the retirement score to the primary user and also provide information as to how the improvements to the score will be achieved. At block 502, embodiments of the invention further include receiving previously calculated retirement scores comprising retirement score and impact retirement score of the primary user and retirement scores of the secondary users and user profiles of the primary user and associated secondary users. The system then determines possible solutions or options based on the retirement scores and the change number to (1) improve low retirement score to within the threshold value if the impact retirement score is lesser than the threshold value and/or (2) further enhance or improve the impact retirement score even if the score is optimal. Thus, each identified product is tailored to the individual it is generated for. For instance, on determining that the primary user's second impact retirement score is low due to a life event of a child going to college, the system may determine that the primary user would benefit from a savings account. As another example, the system may determine that the primary user would improve his impact retirement score by purchasing elder care for an aging parent. For example, if the secondary user is an entity in which the primary user invests, the system may determine that the investment would be more profitable for retirement if the user increases or decreases the monthly payments. In one aspect, the system may identify one or more tips comprising refinancing, donations or investments to receive tax benefits, investments to supplement retirement income or the like. Additionally, the system may determine different factors that may lower the change number of the user based on the financial information. Such factors may include paying off a higher interest loan faster or consolidating debt. The system then analyses the solutions or options to gauge the amount of investment or savings required. For instance the system may determine that $20000 worth additional savings together with refinancing an existing loan with a 1% lower interest rate would achieve the change number and the target retirement score. The system may also look for solutions or options that help a primary user to improve the impact retirement score further even if the score is equal to or are better than the threshold value.

The system may identify user location and financial products currently held by the primary user by analyzing the user profile, as illustrated in block 506. The location may include the primary geographic location the user resides and/or spends an amount of time in. In this way, the system may identify and create a financial analysis of the geographic location, recognizing that various geographic locations have varying cost associated therewith. Furthermore, the system may identify financial institution products associated with the user. These may include financial accounts such as savings accounts, checking accounts, money market accounts, or the like. Furthermore, this may include any financial products the user has directed to financial savings for retirement. Next, as illustrated in block 508, the process continues by reviewing the user financial products and identifying user spend. Once reviewed, the system may identify financial products that, if implemented by the user, would improve the user's retirement score, as illustrated in block 510. These financial products may include financial accounts, insurance, investment options, or the like available in the market currently which help implement the solutions identified at block 504.

The financial products may be products that the user qualifies for based on the retirement scores. The determination of the appropriate financial products may be based on inputting the financial product into a generation system or recreation scenario system. In this way, the system may input an identified financial determine a new retirement score for each of the possible products and/or solutions to determine the effect of the solution on the impact retirement score at block 512. As such, the system may determine if the user's retirement score is positively or negatively affected by the implementation of the product. The system may input, into a simulation, the financial product at one or more times throughout the history of the user and subsequently generate a projected retirement score that incorporates the added product. This newly generated, projected retirement score may be compared to the user's current retirement score to see if the simulated impact of the financial product may positively or negatively impact the user's retirement score. In some embodiments comparison is the determination of the difference between the projected retirement score and the existing current retirement score. The product may be geared towards improvement on retirement score, the first impact retirement score or the second impact retirement score or a combination. On determination that one or more financial products positively impact the user's retirement scores, the system then initiates a presentation of one or more tips on the retirement planning interface on the user device to enable the user to improve the low retirement score to within the average retirement score associated with the one or more users. The presentation includes the identified products and information regarding by how much and when they would impact each of the retirement scores.

In some embodiments on identifying available financial products, the system sends notifications to the user device comprising the identified financial products and activation links to implement the products. In some embodiments the system, in response to identifying products, automatically initiates action to shift the user into appropriate financial products or automatically implements the products at block 514. For instance the system may initiate a phone call for a free consultation with a financial advisor. For example, if the system determines that the user requires to save a certain amount, the system might automatically initiate the opening of a savings account and only then the seek confirmation from the user. In some embodiments the system obtains authorization from the user prior to automatically initiating action to activate or implement the products.

In some embodiments the system continuously monitors the user profile of the primary user and alerts the user when one or more transactions of the user affect the impact retirement score. In response to determining that a particular solution has been implemented or one or more financial products (either the ones offered by the system or independently identified by the primary user) have been implemented the system calculates a new retirement score and/or impact retirement score and updates the user profile. The system then sends a confirmation to the primary user via a network to the user device. The confirmation may also indicate one or more of the improvement to the scores, new calculated scores, an improvement trajectory and further improvement needed. In response to determining that a solution has not been implemented or at least one financial product has not been implemented the system transmits the identified financial products along with activation links for each of them to the user device associated with the primary user. In some embodiments the system also identifies newer financial products and transmits them to the user device associated with the primary user along with potential improved scores if the products were implemented. In some embodiments the system initiates one or more periodic alerts, reminders and/or notifications to enable the primary user to implement the one or more financial products. The notifications, alerts and reminders may be in writing, phone calls, email messages, audible alerts or any other suitable means of communication.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for retirement planning to determine the impact of one or more secondary users on a primary user's retirement, the system comprising:
at least one memory device;
at least one communication device connected to a distributed network;
at least one processing device operatively coupled to the at least one memory device; and
a module stored in the at least one memory device comprising executable instructions that when executed by the at least one processing device, cause the at least one processing device to:
receive retirement information of the primary user, wherein the retirement information comprises a primary user profile;
store into a structured database connected to the distributed network, the retirement information of the primary user;
calculate a retirement score based on the primary user profile, wherein the retirement score is an estimate of the primary user's preparedness for retirement at a predetermined future date;
analyze the primary user profile to determine one or more relationships of the primary user with the one or more secondary users;
determine which of the one or more secondary users affect the calculated retirement score, wherein determining further comprises:
determining one or more user profiles associated with each of the one or more secondary users;
analyzing the one or more user profiles to determine if the one or more secondary users presently affect the calculated retirement score and/or to identify one or more life events likely to occur at a predetermined date in the one or more secondary users' future to determine which of the one or more life events affect the primary user's retirement score; and
linking the one or more user profiles associated with the one or more secondary users to the primary user profile based on at least determining that one or more secondary users and/or the one or more life events likely to occur at the predetermined date in the one or more secondary users' future affect the primary user's retirement score;
determine an impact retirement score for the primary user based on at least determining that the one or more secondary users and/or the one or more life events likely to occur at the predetermined date in the one or more secondary users' future affect the primary user's retirement score;
determine the impact of the one or more secondary users on the primary user's preparedness for retirement, wherein determining further comprises comparing the impact retirement score with a threshold value;
identify one or more options for the primary user to improve the impact retirement score, based on at least determining that the impact retirement score is lesser than the threshold value, wherein identifying the one or more options further comprises determining benefits available to the primary user if the one or more options were implemented; and
transmit control signals configured to cause a user device associated with the primary user to receive the one or more options and the determined benefits available, wherein transmitting control signals further comprises enabling the primary user to activate the one or more options through a retirement planning interface of the user device.

2. The system of claim 1, wherein the module further comprises instructions that cause the at least one processing device to:
determine whether the primary user has activated the one or more options received through the retirement planning interface of the user device;
implement the one or more options based on at least determining that the primary user has activated the one or more options; and
update the impact retirement score based on at least determining that at least one of the one or more options has been implemented, wherein updating the impact retirement score further comprises transmitting control signals configured to cause the user device to receive a notification indicating confirmation of the implementation and the updated impact retirement score.

3. The system of claim 1, wherein the module further comprises instructions that cause the at least one processing device to:
determine whether the primary user has activated the one or more options received through the retirement planning interface of the user device;
initiate a presentation of the one or more identified options on the retirement planning interface of the user device on determination that the primary user has not activated at least one of the one or more options, wherein initiating the presentation further comprises transmitting control signals configured to cause the user device to receive a notification, wherein the notification comprises an audible alert.

4. The system of claim 1, wherein calculating the retirement score based on the primary user profile further comprises:
access assets and liabilities of the primary user over a network of servers, wherein the assets include illiquid assets and liquid assets;
determine asset values and liability values;
determine the primary user profile comprising an age of the primary user, wherein the primary user profile indicates a lifestyle of the primary user;
determine fund in-flows and fund out-flows for the assets and the liabilities over a past time period by analyzing transactions for the assets and the liabilities;
determine estimated rates of return for the assets that provide returns; and
determine financial behavior of the primary user, wherein the financial behavior comprises at least one of a spending behavior, investment behavior, and savings behavior.

5. The system of claim 1, wherein the module further comprises instructions that cause the at least one processing device to:
initiate a presentation on the retirement planning interface of the user device to enable the primary user to customize at least one of the one or more relationships, the one or more secondary users and the one or more life events.

6. The system of claim 1, wherein the module further comprises instructions that cause the at least one processing device to:
determine one or more retirement scores associated with each of the one or more secondary users based on at least linking the one or more profiles associated with the one or more secondary users to the primary user profile.

7. The system of claim 1, wherein the module further comprises instructions that cause the at least one processing device to:
determine a confidence score associated with the impact retirement score, wherein the confidence score indicates the likelihood of occurrence of the one or more life events.

8. The system of claim 1, wherein the module further comprises instructions to cause the at least one processing device to:
compare the impact retirement score with the threshold value to determine that the impact retirement score is equal to or greater than the threshold value;
transmit control signals configured to cause the user device to receive a notification indicating the determined the impact retirement score and that the impact retirement score is optimal, based on at least determining that the impact retirement score is equal to or greater than the threshold value;
identify one or more options for the primary user to further improve the impact retirement score to determine the additional benefits available; and
transmit control signals configured to cause the user device associated with the primary user to receive the one or more options and the determined additional benefits available, wherein transmitting control signals further comprises enabling the primary user to activate the one or more options through a retirement planning interface of the user device.

9. The system of claim 1, wherein the module further comprises instructions to cause the at least one processing device to:
identify one or more available financial products to implement the one or more options;
generate a plurality of scenarios by giving the identified one or more financial products as an input to a recreation scenario system; and
determine whether the one or more financial products improve the impact retirement score to generate a projected impact retirement score that incorporates the one or more financial products, wherein the benefits available is at least the difference between the impact retirement score and the projected impact retirement score.

10. A computer program product for retirement planning to determine the impact of one or more secondary users on a primary user's retirement, comprising a non-transitory computer-readable storage medium having computer-executable instructions to:
receive retirement information of the primary user, wherein the retirement information comprises a primary user profile;
store into a structured database connected to the distributed network, the retirement information of the primary user;
calculate a retirement score based on the primary user profile, wherein the retirement score is an estimate of the primary user's preparedness for retirement at a predetermined future date;
analyze the primary user profile to determine one or more relationships of the primary user with the one or more secondary users;
determine which of the one or more secondary users affect the calculated retirement score, wherein determining further comprises:
determining one or more user profiles associated with each of the one or more secondary users;
analyzing the one or more user profiles to determine if the one or more secondary users presently affect the calculated retirement score and/or to identify one or more life events likely to occur at a predetermined date in the one or more secondary users' future to determine which of the one or more life events affect the primary user's retirement score; and
linking the one or more user profiles associated with the one or more secondary users to the primary user profile based on at least determining that one or more secondary users and/or the one or more life events likely to occur at the predetermined date in the one or more secondary users' future affect the primary user's retirement score;
determine an impact retirement score for the primary user based on at least determining that the one or more secondary users and/or the one or more life events likely to occur at the predetermined date in the one or more secondary users' future affect the primary user's retirement score;
determine the impact of the one or more secondary users on the primary user's preparedness for retirement, wherein determining further comprises comparing the impact retirement score with a threshold value;
identify one or more options for the primary user to improve the impact retirement score, based on at least determining that the impact retirement score is lesser than the threshold value, wherein identifying the one or more options further comprises determining benefits available to the primary user if the one or more options were implemented; and
transmit control signals configured to cause a user device associated with the primary user to receive the one or more options and the determined benefits available, wherein transmitting control signals further comprises enabling the primary user to activate the one or more options through a retirement planning interface of the user device.

11. The computer program product of claim 10, wherein the non-transitory computer-readable storage medium further having computer-executable instructions to:
determine whether the primary user has activated the one or more options received through the retirement planning interface of the user device;
implement the one or more options based on at least determining that the primary user has activated the one or more options; and
update the impact retirement score based on at least determining that at least one of the one or more options has been implemented, wherein updating the impact retirement score further comprises transmitting control signals configured to cause the user device to receive a notification indicating confirmation of the implementation and the updated impact retirement score.

12. The computer program product of claim 10, wherein calculating the retirement score based on the primary user profile further comprises:
access assets and liabilities of the primary user over a network of servers, wherein the assets include illiquid assets and liquid assets;
determine asset values and liability values;
determine the primary user profile comprising an age of the primary user, wherein the primary user profile indicates a lifestyle of the primary user;
determine fund in-flows and fund out-flows for the assets and the liabilities over a past time period by analyzing transactions for the assets and the liabilities;
determine estimated rates of return for the assets that provide returns; and
determine financial behavior of the primary user, wherein the financial behavior comprises at least one of a spending behavior, investment behavior, and savings behavior.

13. The computer program product of claim 10, wherein the non-transitory computer-readable storage medium further having computer-executable instructions to:
initiate a presentation on the retirement planning interface of the user device to enable the primary user to customize at least one of the one or more relationships, the one or more secondary users and the one or more life events.

14. The computer program product of claim 10, wherein the non-transitory computer-readable storage medium further having computer-executable instructions to:
determine a confidence score associated with the impact retirement score, wherein the confidence score indicates the likelihood of occurrence of the one or more life events.

15. The computer program product of claim 10, wherein the non-transitory computer-readable storage medium further having computer-executable instructions to:
identify one or more available financial products to implement the one or more options;
generate a plurality of scenarios by giving the identified one or more financial products as an input to a recreation scenario system; and
determine whether the one or more financial products improve the impact retirement score to generate a projected impact retirement score that incorporates the one or more financial products, wherein the benefits available is at least the difference between the impact retirement score and the projected impact retirement score.

16. A method for retirement planning to determine the impact of one or more secondary users on a primary user's retirement, comprising:
receiving, using a computing device processor, retirement information of the primary user, wherein the retirement information comprises a primary user profile;
storing into a structured database connected to the distributed network, using the computing device processor, the retirement information of the primary user;
calculating, using the computing device processor, a retirement score based on the primary user profile, wherein the retirement score is an estimate of the primary user's preparedness for retirement at a predetermined future date;
analyzing, using the computing device processor, the primary user profile to determine one or more relationships of the primary user with the one or more secondary users;
determining, using the computing device processor, which of the one or more secondary users affect the calculated retirement score, wherein determining further comprises:
determining one or more user profiles associated with each of the one or more secondary users;
analyzing the one or more user profiles to determine if the one or more secondary users presently affect the calculated retirement score and/or to identify one or more life events likely to occur at a predetermined date in the one or more secondary users' future to determine which of the one or more life events affect the primary user's retirement score; and
linking the one or more user profiles associated with the one or more secondary users to the primary user profile based on at least determining that one or more secondary users and/or the one or more life events likely to occur at the predetermined date in the one or more secondary users' future affect the primary user's retirement score;
determining, using the computing device processor, an impact retirement score for the primary user based on at least determining that the one or more secondary users and/or the one or more life events likely to occur at the predetermined date in the one or more secondary users' future affect the primary user's retirement score;
determining, using the computing device processor, the impact of the one or more secondary users on the primary user's preparedness for retirement, wherein determining further comprises comparing the impact retirement score with a threshold value;
identifying, using the computing device processor, one or more options for the primary user to improve the impact retirement score, based on at least determining that the impact retirement score is lesser than the threshold value, wherein identifying the one or more options further comprises determining benefits available to the primary user if the one or more options were implemented; and
transmitting, using the computing device processor, control signals configured to cause a user device associated with the primary user to receive the one or more options and the determined benefits available, wherein transmitting control signals further comprises enabling the primary user to activate the one or more options through a retirement planning interface of the user device.

17. The method of claim 16, further comprising:
determining, using the computing device processor, whether the primary user has activated the one or more options received through the retirement planning interface of the user device;
implementing, using the computing device processor, the one or more options based on at least determining that the primary user has activated the one or more options; and
updating, using the computing device processor, the impact retirement score based on at least determining that at least one of the one or more options has been implemented, wherein updating the impact retirement score further comprises transmitting control signals configured to cause the user device to receive a notification indicating confirmation of the implementation and the updated impact retirement score.

18. The method of claim 16, wherein calculating, using the computing device processor, the retirement score based on the primary user profile further comprises:
accessing assets and liabilities of the primary user over a network of servers, wherein the assets include illiquid assets and liquid assets;
determining asset values and liability values;
determining the primary user profile comprising an age of the primary user, wherein the primary user profile indicates a lifestyle of the primary user;
determining fund in-flows and fund out-flows for the assets and the liabilities over a past time period by analyzing transactions for the assets and the liabilities;
determining estimated rates of return for the assets that provide returns; and
determining financial behavior of the primary user, wherein the financial behavior comprises at least one of a spending behavior, investment behavior, and savings behavior.

19. The method of claim 16, further comprising:
initiating, using the computing device processor, a presentation on the retirement planning interface of the user device to enable the primary user to customize at least one of the one or more relationships, the one or more secondary users and the one or more life events.

20. The method of claim 16, further comprising:
determining, using the computing device processor a confidence score associated with the impact retirement score, wherein the confidence score indicates the likelihood of occurrence of the one or more life events.
